(19) United States
(12) Patent Application Publication
(10) Pub. No.: US 2010/0140192 A1
(43) Pub. Date: Jun. 10, 2010

(54) Dual port SPA suction fitting with unidirectional water flow

(76) Inventors: Brooks Hilton, Oxnard, CA (US); M. rEZA Mirzaei, Agoura Hills, CA (US); Frank Hinjosa, Santa Paula, CA (US)

Correspondence Address: SANDRA LEE LIPKIN A LAW CORPORATION, P.O.Box 3518, VENTURA, CA, 93006, US

(21) Appl. No.: 12/384,433

(22) Filed: Apr. 3, 2009

Related U.S. Application Data
(60) Provisional application No. 61/201,322, filed on Dec. 8, 2008.

(51) Int. Cl. E04H 4/14; C02F 1/00

(52) U.S. Cl. 210/805; 4/507

(57) ABSTRACT

A uniquely designed dual port spa suction fitting that uses two channels for the intake of water to be filtered that are bridged together to eliminate high speed zones and provide for a more even distribution of suction force across the suction openings. The cover has a concave shape with a curved perimeter and sidewall. The cover, the curved perimeter and the sidewall all contain a plurality of apertures allowing for the intake of water into the filter. The apertures provide for unidirectional flow, thereby reducing the hazard caused by hair entanglement. An alternate embodiment includes a sump that is attached between the cover and the two spa fittings.

### REFERENCE TO PRIOR APPLICATION

This application claims the priority of provisional application 61/201,322, filed Dec. 8, 2008 entitled TWIN SUPER FLOW SPA SUCTION OUTLET WITH UNIQUE DUAL PORT SUCTION FITTING by Brooks Hilton, Ray Mirzaei, Frank Hinjosa.

### BACKGROUND OF THE INVENTION

1. Field of the Invention

The present invention relates generally to the field of drains for spas and whirlpool baths and more particularly to an improved spa suction fitting design that provides for improved safety in suction capacity without restricting available foot space.

2. Description of the Prior Art

A hot tub or spa is a large tub or small pool filled with heated water and is used for soaking, relaxation, massage and/or hydrotherapy. The plumbing of a spa consists of several distinct systems, including a suction system that allows for the return of water to a filter through a pump in order to keep a constant flow of water during use. Suction fittings cover the suction system to prevent the entrapment of body parts and other debris from getting sucked into the system and possible drowning in the case that body parts and/or hair get entangled.

Traditional suctions offered for spas and whirlpools have had only one suction port in the suction system, thereby creating a high velocity zone in the body of water and creating an excessive amount of turbulence that contributes to the problem of hair entrapment and hair tangling. The instant invention provides for an improved system that reduces the high velocity patches in the spa and the excessive turbulence while at the same time providing for installation of the fitting under the bather's seat and between the bather's legs providing for less restriction of the available foot space in the spa.

The instant invention seeks to provide a suction fitting that overcomes the shortcomings of the prior art.

### SUMMARY OF THE INVENTION

The preferred embodiment of the present invention teaches an improved suction fitting for a filter pump for use in artificial bodies of water such as spas, whirlpools and the like comprising a substantially oblong cover having a slightly concave shape; a rounded perimeter extending from the cover; a sidewall extending downward from the perimeter wherein the sidewall is substantially perpendicular to the cover wherein the cover, the perimeter and the sidewall contain a plurality of apertures to allow for the intake of water; a first channel extending downward from the cover; and a second channel extending downward from the cover and in a position substantially parallel to the first channel.

The above embodiment can be further modified by defining that the suction fitting attaches to a sump which then attaches to the first channel and the second channel.

An alternate embodiment of instant invention teaches an improved method for the filtration of water in artificial bodies of water such as spas, whirlpools and the like comprising: attachment of an improved suction fitting having a substantially oblong cover having a slightly concave shape to a frame that attaches to a first channel and a second channel wherein the first channel and the second channel are substantially parallel to each other and wherein the cover has a rounded perimeter that connects the cover to a sidewall which extends downward from the cover in a substantially perpendicular orientation and wherein the cover, perimeter and sidewall contain a plurality of apertures for the intake of water; placement of the cover and attached channels over an opening in a body of water, the opening connecting to a filter through a pump that receives water through the apertures in such a way as to spread the filtration force between the first channel and the second channel; and beginning operation of the filter.

The above embodiment can be further modified by defining that a sump is attached between the cover and the first and second channels.

### BRIEF DESCRIPTION OF THE DRAWINGS

This invention can better be understood by reference to the drawings, provided for exemplary purposes, and in which:

FIG. 1 is an isometric view of the preferred embodiment of the instant invention.

FIG. 2 is taken along the line 2-2 in FIG. 1.

FIG. 3 is an exploded view of the preferred embodiment.

FIG. 4 is an exploded view of an alternate embodiment.

### DETAILED DESCRIPTION OF A PREFERRED EMBODIMENT

The instant invention is a spa suction fitting that is designed to fit in the foot well of spas in a vertical position. The design provides for the necessary and safe suction capacity without restricting the available foot space in the spa well. The instant design provides also for the installation under the bather seat and between the bather's legs. The design is unique and provides for an enhanced aesthetic of the spa with a modernized aerodynamic appearance.

Using a “Siamese” design concept, two traditional spa suction fittings are bridged together to eliminate high speed zones and provide for a more even distribution of suction force across the suction openings. This suction fitting provides for portable and self-contained spa applications that include two suction ports while the overall footprint of the fitting does not exceed 12″×6″. This size allows for mounting at the small foot wells of portable spas.

This is an improvement of traditional suction fittings that only have one suction port, thereby creating a high velocity zone and an excessive amount of turbulence that contributes to dangerous hair entrapment and tangling.

With the instant invention, in the case of the blockage of one opening on one side of the suction fitting, the remaining opening restricts the creation of an excessive vacuum as well as the possibility of hair entrapment. The design provides for additional suction relief should one opening be blocked. This is because the two suction ports are specifically positioned in way so as to optimize and adjust the distribution of the suction force and water velocity at suction openings and thereby prevent excessive hair entrapment forces.

Furthermore, the special pattern of the openings on the instant invention's suction face and its perimeter pulls all hair strands, if entrapped, in one direction, thereby avoiding possible hair tangling. Additionally, the design of the internal ribs form segregated suction compartments under the suction fitting fact, contributing to an even distribution of the suction forces and preventing excessive turbulence, thereby reducing hair tangling.

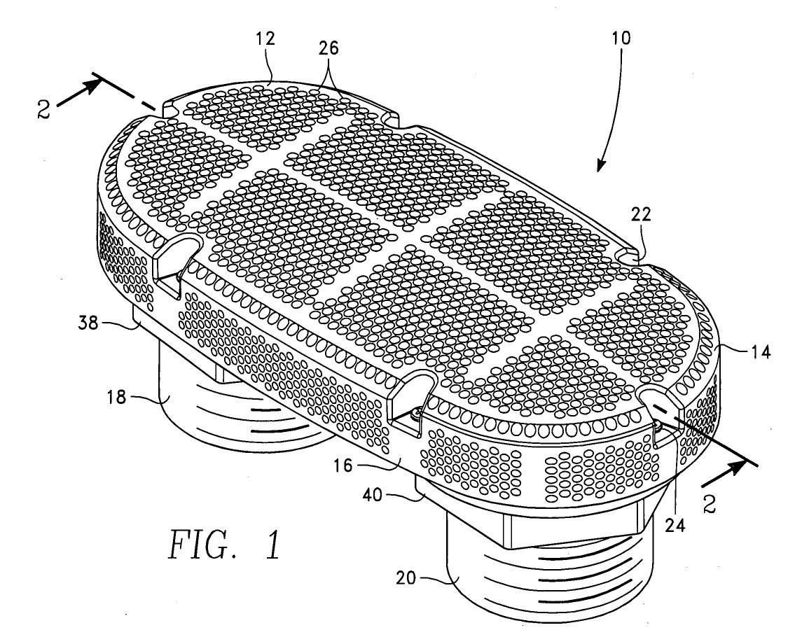

FIG. 1 shows an isometric view of the preferred embodiment of the instant invention. The preferred embodiment of the cover 10 includes a top portion 12 that is substantially oblong in shape. The top portion 12 has a slightly concave shape and is rounded at the perimeter 14. Downward from the perimeter 14 is a sidewall 16 that extends around the perimeter 14 of the top portion 12. Beneath the top portion 12 are a pair 18, 20 of channels. It is these channels 18, 20 that provide the dual suction.

Along the perimeter 14 of the top cover 12 are a series of indentions 22, here showing six, but it is to be understood that this number is variable. In the interior of these indentions 22 is a place to attach screws 24 that help keep the apparatus together.

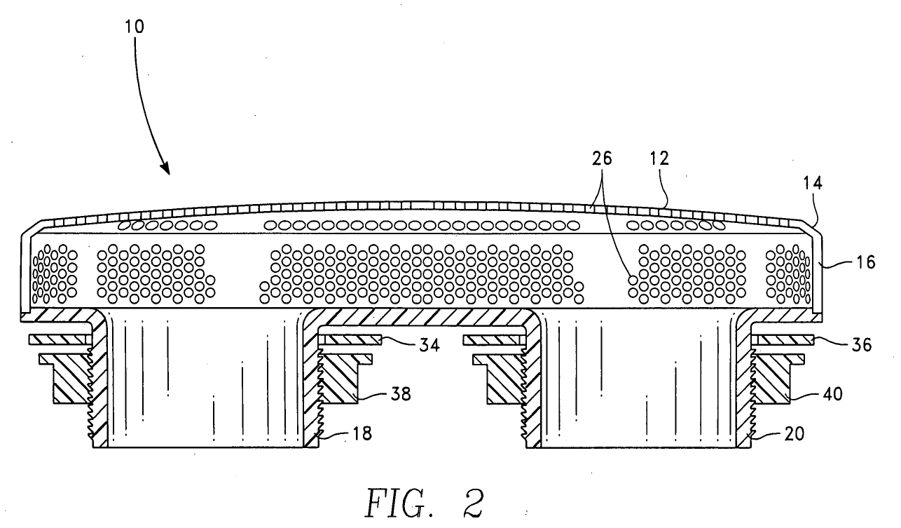

Included along the top cover 12, the perimeter 14 and the sidewall 16 are a plurality of apertures 26 that provide an inlet into the filter of water from the main body of water found in the spa. These features are all visible in cross section in FIG. 2. These apertures 26, due to their placement on the concave top and curved perimeter in a uniform direction, provide for a unidirectional flow which improves safety in the event that hair does get tangled, because the flow is in one direction and not in multiple directions.

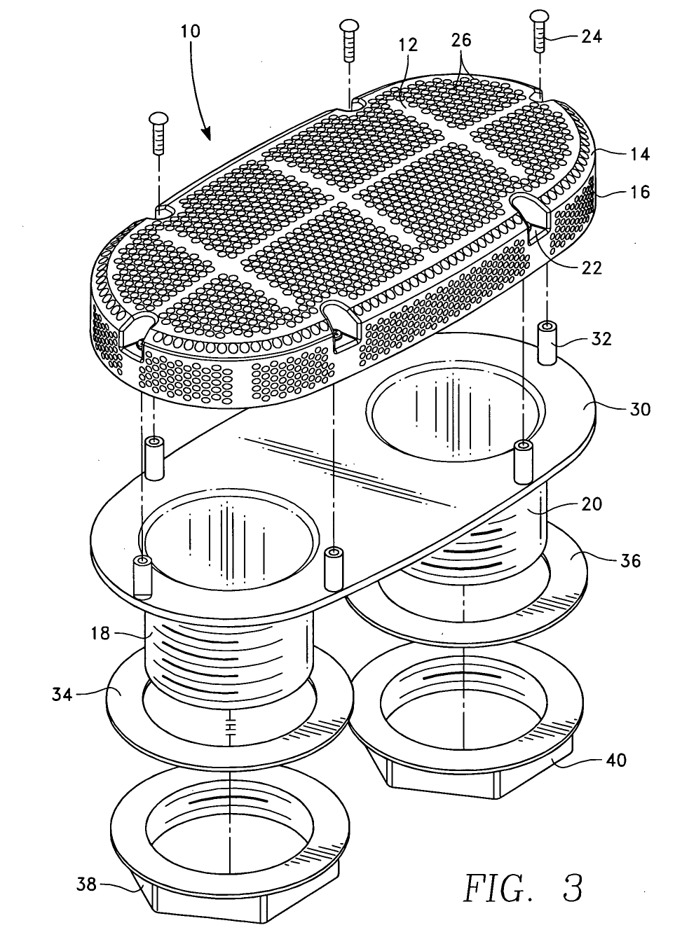

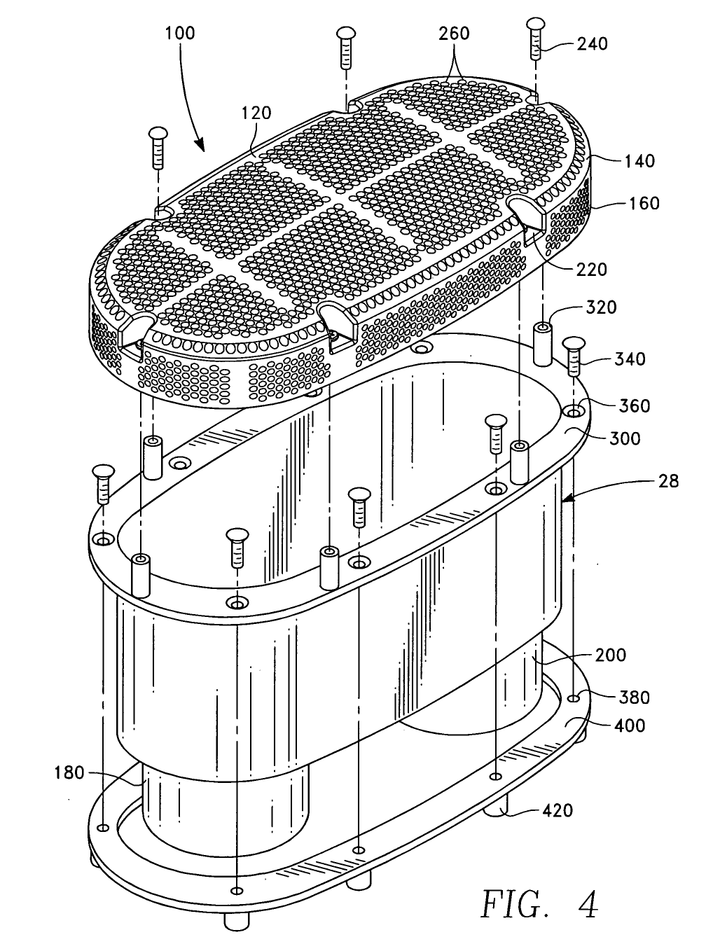

FIGS. 3 and 4 show exploded views of the invention with FIG. 3 showing the preferred embodiment while FIG. 4 shows an alternate embodiment wherein the top portion 10 is attached to a sump 28 before it attaches to the channels 18, 20. In FIG. 3 the top portion 12 (which is one piece and includes the perimeter 14 and the sidewall 16) is attached to a frame 30 that includes sleeves 32 that receive the screws 24 that are attached to the top portion 12 at the indentations 22. The frame 30 includes the bottom channels 18, 20 as part of its structure. Gaskets 34, 36 seal around the channels 18, 30 and are held in place with bolt-like fittings 38, 40.

The alternate embodiment includes a sump 28 as part of the entire structure. In this embodiment the apparatus 100 includes a top portion 120 that is substantially concave in shape and that has a rounded perimeter 140 that attaches to a sidewall 160 that is substantially perpendicular to the concave top portion 120. In this embodiment, the screws 240 that attach to indentations 220 on the top portion 120 attach to sleeves 320 found on the top lip 300 of the sump 28. The top lip 300 of the sump 300 includes holes 360 for the placement therein of another set of screws 340 that attach to a bottom frame 400 through corresponding holes 380. The channels 180, 200 extend from the bottom of the sump 28 rather than the bottom of the top portion 120. The bottom frame 400 of the apparatus includes protrusions 420 that allow for easy attachment to a filter.

The illustrations and examples provided herein are for explanatory purposes only and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

What is claimed is:

1. An improved suction fitting for a filter pump for use in artificial bodies of water such as spas, whirlpools and the like comprising
a substantially oblong cover having a slightly concave shape;
a rounded perimeter extending from said cover;
a sidewall extending downward from said perimeter wherein said sidewall is substantially perpendicular to said cover wherein said cover, said perimeter and said sidewall contain a plurality of apertures to allow for the intake of water;
a first channel extending downward from said cover; and
a second channel extending downward from said cover and in a position substantially parallel to said first channel.

2. The improved cover of claim 1 wherein said suction fitting attaches to a sump which then attaches to said first channel and said second channel.

3. An improved method for the filtration of water in artificial bodies of water such as spas, whirlpools and the like comprising:
attachment of an improved suction fitting having a substantially oblong cover having a slightly concave shape to a frame that attaches to a first channel and a second channel wherein said first channel and said second channel are substantially parallel to each other and wherein said cover has a rounded perimeter that connects said cover to a sidewall which extends downward from said cover in a substantially perpendicular orientation and wherein said cover, perimeter and sidewall contain a plurality of apertures for the intake of water;
placement of said cover and attached channels over an opening in a body of water, said opening connecting to a filter through a pump that receives water through said apertures in such a way as to spread the filtration force between said first channel and said second channel; and
beginning operation of said filter.

4. The improved method as defined in claim 3 wherein a sump is attached between said cover and said first and second channels.
